(19) United States
(12) Patent Application Publication
(10) Pub. No.: US 2011/0189455 A1
(43) Pub. Date: Aug. 4, 2011

(54) METHOD FOR PRODUCING LIQUID CRYSTALLINE POLYESTER COMPOSITION, AND CONNECTOR

(75) Inventors: Yoshiyuki FUKUHARA, Tsuchiura-shi (JP); Yasuo MATSUMI, Tsukuba-shi (JP)

(73) Assignee: SUMITOMO CHEMICAL COMPANY, LIMITED, Tokyo (JP)

(21) Appl. No.: 13/014,982

(22) Filed: Jan. 27, 2011

(30) Foreign Application Priority Data
Jan. 29, 2010 (JP) 2010-018093

(51) Int. Cl. B32B 5/00; C08K 3/34

(52) U.S. Cl. 428/220; 524/449

(57) ABSTRACT

The present invention provides a method for producing a composition, the method feeding a liquid crystalline polyester and mica into an extruder having a vent section, and melt-kneading them under the conditions where the degree of pressure reduction of the vent section is −0.06 MPa or less in terms of a gauge pressure. The production method can provide a composition containing a liquid crystalline polyester and mica, the composition being less likely to cause blister event at a high temperature.

### BACKGROUND OF THE INVENTION

(1) Field of the Invention

The present invention relates to a method for producing a liquid crystalline polyester composition. The present invention also relates to a connector which is obtained by molding a liquid crystalline polyester composition obtained by the production method.

(2) Description of Related Art

With the progress of miniaturization and light-weighting/thinning of an electrical and electronic equipment, a pitch of a connector used therefor has recently become narrower. Therefore, a liquid crystalline polyester is preferably used as a molding material thereof since it is excellent in melt fluidity, heat resistance, and mechanical properties. In the liquid crystalline polyester, molecular chains are likely to be oriented in a flow direction upon molding, and anisotropy on a mold shrinkage ratio or mechanical properties is likely to occur in a flow direction and a direction perpendicular to the flow direction. Therefore, in order to reduce the anisotropy, fibrous and plate-like fillers are often blended and used. For example, JP-A-4-202558 discloses a composition in which mica as a plate-like filler is blended in a liquid crystalline polyester, and this composition is produced by feeding a liquid crystalline polyester and mica in an extruder, followed by melt kneading.

### SUMMARY OF THE INVENTION

With the composition obtained by the method disclosed in JP-A-4-202558, blister is likely to occur at a high temperature. For example, blister is likely to occur on a surface of a connector upon soldering in the case of surface mounting of a connector obtained by molding the composition. Thus, one of objectives of the present invention is to provide a method capable of producing a composition which contains a liquid crystalline polyester and mica, and is less likely to cause blister at a high temperature.

In order to achieve the object, the present invention provides a method for producing a composition, the method comprising the steps of:

feeding a liquid crystalline polyester and mica in an extruder having a vent section, and

melt-kneading them under the conditions where the degree of pressure reduction of the vent section is −0.06 MPa or less in terms of a gauge pressure.

The present invention also provided a connector obtained by molding a liquid crystalline polyester composition by the production method described above.

According to the present invention, a composition which contains a liquid crystalline polyester and mica can be obtained. With the composition, it is difficult that blister occurs at a high temperature. The composition is suitably used as a molding material for a molded article used at a high temperature, such as parts for surface mounting by soldering, particularly a connector.

### <Liquid Crystalline Polyester>

A liquid crystalline polyester is a polyester called a thermotropic liquid crystalline polymer, and is suitably obtained by polymerizing an aromatic hydroxycarboxylic acid, an aromatic dicarboxylic acid and an aromatic diol, and forms an anisotropic melt at a temperature of 400° C. or lower.

In order to produce a liquid crystalline polyester more easily, it is also possible to polymerize after converting a portion or all of raw monomers such as an aromatic hydroxycarboxylic acid, an aromatic dicarboxylic acid and an aromatic diol into an ester-forming derivative.

Examples of the ester-forming derivative include those in which carboxyl groups are converted into haloformyl groups or acyloxycarbonyl groups, and those in which carboxyl groups are converted into alkoxycarbonyl groups or aryloxycarbonyl groups in the case of the aromatic hydroxycarboxylic acid or aromatic dicarboxylic acid having carboxyl groups in a molecule. Also, in the case of the aromatic hydroxycarboxylic acid or aromatic diol having phenolic hydroxyl groups in a molecule, examples thereof include those in which phenolic hydroxyl groups are converted into acyloxy groups.

Examples of a structural unit derived from the aromatic hydroxycarboxylic acid capable of constituting a liquid crystalline polyester include the followings.

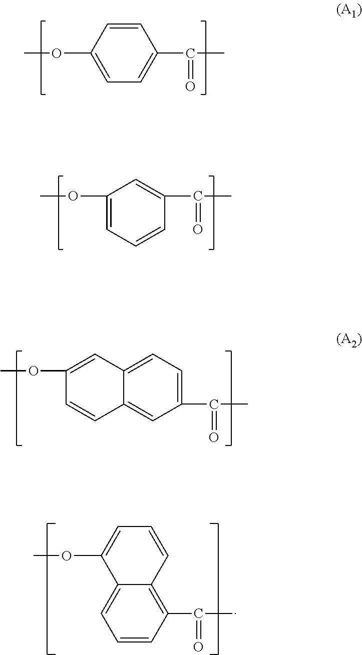

Examples of the structural unit also include those in which each of a portion of hydrogen atoms present in the aromatic ring of each of the structural units is independently substituted with a halogen atom, an alkyl group or an aryl group.

Examples of a structural unit derived from the aromatic dicarboxylic acid capable of constituting a liquid crystalline polyester include the followings.

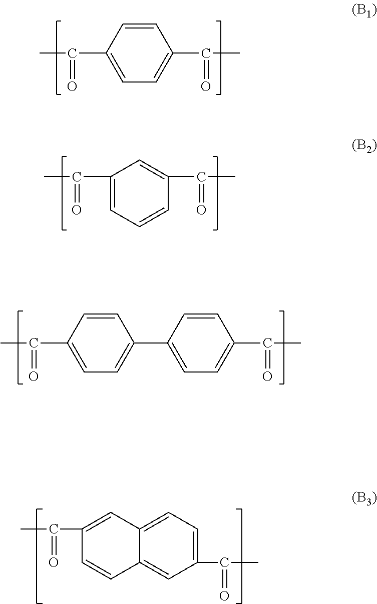

Examples of the structural unit also include those in which each of a portion of hydrogen atoms present in the aromatic ring of each of the structural units is independently substituted with a halogen atom, an alkyl group or an aryl group.

Examples of a structural unit derived from the aromatic diol capable of constituting a liquid crystalline polyester include the followings.

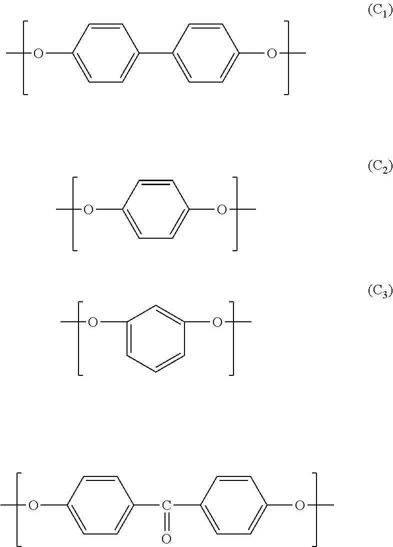

Examples of the structural unit also include those in which each of a portion of hydrogen atoms present in the aromatic ring of each of the structural units is independently substituted with a halogen atom, an alkyl group or an aryl group.

Examples of the respective halogen atom include a fluorine atom, a chlorine atom and a bromine atom. Examples of the respective alkyl group include a methyl group, an ethyl group and a butyl group. The number of carbon atoms may be from 1 to 4. Examples of the respective aryl group include a phenyl group.

The liquid crystalline polyester preferably has (A₁) as a structural unit thereof, and the content of (A₁) is preferably 30 mol % or more based on the total of all structural units. Combinations of structural units of the liquid crystalline polyester are preferably those shown in the following (a) to (f):

(a): Combination of (A₁) and (B₁) and/or (B₂) and (C₁),

### (b): Combination of (A₁) and (A₂),

(c): Combination (a) in which a portion of (A₁) is replaced with (A₂),
(d): Combination (a) in which a portion of (B₁) is replaced with (B₃),
(e): Combination (a) in which a portion of (C₁) is replaced with (C₃), and
(f): Combination (b) including (B₁) and (C₁) added therein.

Among them, the combination (a) of a structural unit derived from p-hydroxybenzoic acid as (A₁) and a structural unit derived from terephthalic acid as (B₁) and/or a structural unit derived from isophthalic acid as (B₂) and a structural unit derived from 4,4-dihydroxybiphenyl as (C₁) is preferred. In the combination (a), preferably, a molar ratio (C₁)/(A₁) is from 0.2 to 1.0, a molar ratio [(B₁)+(B₂)]/(C₁) is from 0.9 to 1.1, and a molar ratio (B₂)/(B₁) is more than 0 and 1 or less. When a liquid crystalline polyester having such a structural unit composition and obtained by polymerization in the presence of a heterocyclic organic base compound described below is used, it is possible to obtain a composition in which the occurrence of blister at a high temperature is further suppressed.

The liquid crystalline polyester is preferably obtained by a production method including an acylation step of acylating phenolic hydroxyl groups of an aromatic diol and an aromatic hydroxycarboxylic acid with fatty acid anhydrides (acetic anhydride, etc.) to obtain an acrylate of the aromatic diol and an acylate of the aromatic hydroxycarboxylic acid; and a polymerization step of polymerizing by an ester exchange reaction so as to replace acyl groups of these acrylates with residues in which hydroxyl groups are removed from carboxyl groups of acrylates of the aromatic dicarboxylic acid and the aromatic hydroxycarboxylic acid to obtain a liquid crystalline polyester.

The acylation step and/or the polymerization step may be carried out in the presence of a heterocyclic organic base compound represented by the following formula:

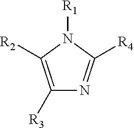

wherein R₁ to R₄ each independently represents a hydrogen atom, an alkyl group having 1 to 4 carbon atoms, a hydroxymethyl group, a cyano group, a cyanoalkyl group where an alkyl group has 1 to 4 carbon atoms, a cyanoalkoxy group where an alkoxy group has 1 to 4 carbon atoms, a carboxyl group, an amino group, an aminoalkyl group having 1 to 4 carbon atoms, an aminoalkoxyl group having 1 to 4 carbon atoms, a phenyl group, a benzyl group, a phenylpropyl group, or a formyl group.

The heterocyclic organic base compound represented by the above formula is preferably 1-methylimidazole or 1-ethylimidazole.

The use amount of this heterocyclic organic base compound is preferably from 0.005 to 1 part by mass based on 100 parts by weight of the total amount of raw monomers such as an aromatic dicarboxylic acid, an aromatic diol and an aromatic hydroxycarboxylic acid. From the viewpoints of color tone and productivity of the molded object obtained, the amount is more preferably from 0.05 to 0.5 parts by weight. The heterocyclic organic base compound may be temporarily present during the acylation reaction and the ester exchange reaction, and may be added immediately before initiation of the acylation reaction, during the acylation reaction, or between the acylation reaction and the ester exchange reaction. The liquid crystalline polyester thus obtained has an advantage such as more excellent melt fluidity.

The use amount of the fatty acid anhydride is preferably from 1.0 to 1.2 times by mole, more preferably from 1.0 to 1.15 times by mole, still more preferably from 1.03 to 1.12 times by mole, and particularly preferably from 1.05 to 1.1 times by mole the total amount of phenolic hydroxyl groups contained in raw monomers such as an aromatic diol and an aromatic hydroxycarboxylic acid.

The acylation reaction is preferably carried out at 130 to 180° C. for 30 minutes to 20 hours, and more preferably carried out at 140 to 160° C. for 1 to 5 hours.

The aromatic dicarboxylic acid may be present in the reaction system during the acylation step. In other words, in the acylation step, an aromatic diol, an aromatic hydroxycarboxylic acid and an aromatic dicarboxylic acid may be present in the same reaction system. This is because both of carboxyl groups and optionally substituted substituents in the aromatic dicarboxylic acid are scarcely influenced by a fatty acid anhydride. Therefore, it is possible to use a method in which an aromatic diol, an aromatic hydroxycarboxylic acid and an aromatic dicarboxylic acid are charged in the same reactor and acylation is carried out by a fatty acid anhydride, or a method in which an aromatic diol and an aromatic hydroxycarboxylic acid are charged in a reactor in advance and, after acylation of them by a fatty acid anhydride, a aromatic dicarboxylic acid is charged in the reactor. From the viewpoint of simplification of the operation, the former method is preferred.

The polymerization by the ester exchange reaction is preferably carried out while heating within a range from 130° C. to 400° C. at a temperature rise rate of 0.1 to 50° C./minute, and more preferably carried out while heating within a range from 150° C. to 350° C. at a temperature rise rate of 0.3 to 5° C./minute.

During carrying out the ester exchange reaction, fatty acid such as acetic acid as a by-product and the unreacted fatty acid anhydride such as acetic anhydride are preferably distilled out of the system by evaporation so as to shift equilibrium. Raw monomers evaporated and sublimated together with fatty acid can also be returned to the reactor by condensation or inverse sublimation by refluxing a portion of the fatty acid distilled out and returning it to the reactor.

The acylation reaction and the ester exchange reaction may be carried out using a batch device or a continuous device.

After the polymerization step, it is possible to increase the molecular weight by cooling and solidifying the obtained liquid crystalline polyester and then grinding the solidified liquid crystalline polyester to prepare a powdered liquid crystalline polyester, or granulating the powdered liquid crystalline polyester to prepare a pellet-shaped liquid crystalline polyester, and heating it. An increase of the molecular weight of the liquid crystalline polyester is called solid phase polymerization in the relevant technical field. This solid phase polymerization is particularly effective as the method of increasing the molecular weight of the liquid crystalline polyester. It becomes easy to obtain a liquid crystalline polyester having a suitable flow initiation temperature by increasing the molecular weight of the liquid crystalline polyester. This solid phase polymerization is carried out, for example, by subjecting a solid liquid crystalline polyester to a heat treatment under an atmosphere of an inert gas such as nitrogen, or under reduced pressure for 1 to 20 hours. In this case, examples of the device used in the heat treatment include a dryer, a reactor, an inert oven, a mixer and an electric furnace.

The flow initiation temperature of the liquid crystalline polyester thus obtained is preferably form 270° C. to 400° C., and more preferably from 280° C. to 380° C. When a liquid crystalline polyester having the flow initiation temperature within the above range is used, melt fluidity of the obtained composition is likely to become more satisfactory, and also heat resistance of the molded object obtained becomes more satisfactory. Furthermore, the liquid crystalline polyester is less likely to cause heat deterioration in the melt molding of the composition.

As used herein, the flow initiation temperature means a temperature at which a melt viscosity shows 4,800 Pa·second (48,000 poises) when a hot melt of a liquid crystalline polyester is extruded through a nozzle measuring 1 mm in inner diameter and 10 mm in length at a temperature rise rate of 4° C./minute under a load of 9.8 MPa (100 kg/cm²) using a capillary rheometer equipped with the nozzle, and is known to a person with an ordinary skill in the art as an indicator of a molecular weight of a liquid crystalline polyester (edited by Naoyuki Koide, “Synthesis, Molding and Application of Liquid Crystalline Polymers”, pp. 95-105, CMC, published on Jun. 5, 1987).

### <Mica>

Examples of mica include phlogopite, muscovite, sericite, fluor-phlogopite, K-fluor-tetrasilicic mica, Na-fluor-tetrasilicic mica, Na-taeniolite, and Li-taeniolite, and phlogopite and muscovite are preferred from the viewpoints of electrical insulation properties and heat resistance. Examples of the grinding method in the case of producing mica include a wet grinding method and a dry grinding method, and a wet grinding method is preferred from the viewpoint of particle size distribution.

A volume average particle diameter of mica is preferably from 1 to 100 μm, and more preferably from 20 to 50 μm. When the volume average particle diameter of mica is too small, a resin is likely to sag through a nozzle during injection molding of the obtained composition, resulting in poor moldability in some cases. In contrast, when the volume average particle diameter of mica is too large, a decrease in warp amount of the molded object obtained may become insufficient. The volume average particle diameter of mica can be measured by a laser diffraction particle size measurement apparatus.

The mica may be used in an amount of from 15 to 100 parts by weight, and preferably from 25 to 80 parts by weight, based on 100 parts by weight of the liquid crystalline polyester. When the use amount of mica is too small, it becomes difficult to prevent the occurrence of warp of the molded object obtained, particularly a long connector. In contrast, when the amount is too large, fluidity upon melt molding of the obtained composition becomes insufficient, and thus it becomes difficult to mold. A composition containing mica whose content is within the above range is preferred since it is possible to improve heat resistance of the obtained long connector and to realize practical soldering resistance.

### <Other Components>

From the viewpoint of a mechanical strength of the obtained composition, it is preferred to use, as the filler other than mica, a fibrous filler, and more preferably to use a fibrous inorganic filler.

Examples of the fibrous inorganic filler include a glass fiber, a carbon fiber, wollastonite, an aluminum borate whisker, a potassium titanate whisker, a silica alumina fiber, and an alumina fiber. If necessary, two or more kinds of them may also be used. Among them, a glass fiber, a carbon fiber, wollastonite, an aluminum borate whisker and a potassium titanate whisker are preferred.

A number average fiber diameter of the fibrous inorganic filler is preferably from 0.1 to 20 μm, and more preferably from 0.5 to 15 μm. When the number average fiber diameter of the fibrous inorganic filler is too small, it becomes difficult to suppress the occurrence of warp of the molded object obtained. In contrast, when the number average fiber diameter is too large, melt fluidity of the obtained composition is likely to be impaired. A number average fiber length of the fibrous inorganic filler is preferably from 1 to 300 μm, and more preferably from 5 to 300 μm. When the number average fiber length of the fibrous inorganic filler is too small, it is difficult to improve the mechanical strength of the obtained composition. In contrast, when the number average fiber length is too large, melt fluidity of the obtained composition is likely to be impaired.

It is possible to use, as a resin other than the liquid crystalline polyester, for example, thermoplastic resins such as polyamide, polyester, polyphenylene sulfide, polyetherketone, polycarbonate, polyphenylene ether or a modified compound thereof, polysulfone, polyethersulfone, and polyetherimide; and thermosetting resins such as a phenol resin, an epoxy resin, and a polyimide resin.

Furthermore, it is possible to contain, as additives, additives having an external lubricant effect, for example, mold release improvers such as metal soaps; coloring materials such as dyes and pigments; antioxidants; heat stabilizers; ultraviolet absorbers; antistatic agents; surfactants; higher fatty acids, higher fatty acid esters, higher fatty acid metal salts, fluorocarbon-based surfactants and the like.

### <Method for Producing Composition>

In the present invention, a liquid crystalline polyester, mica and, if necessary, other components are melt-kneaded to produce a composition. This melt kneading is carried out by feeding each component in an extruder having a vent section under the conditions where the degree of pressure reduction of the vent section is −0.06 MPa or less, and preferably −0.08 MPa or less, in terms of a gauge pressure. Whereby, it is possible to obtain a composition which is less likely to cause blister at a high temperature. In this case, the degree of pressure reduction of the vent section is −0.06 MPa or less, and preferably −0.08 MPa or less, in terms of a gauge pressure.

Examples of the extruder include a single-screw extruder and a twin-screw extruder with a mono- or multi-stage vent. In the twin-screw extruder, co-rotating twin-screw extruders with one-line screw to three-line screw can be used, or parallel, inclined or incompletely intermeshing counter-rotating twin-screw extruder may also be used. Among them, a co-rotating twin-screw extruder having one or more vents is preferred.

A screw diameter of the extruder is preferably 50 mm or less, and more preferably 45 mm or less. Also, a ratio L/D of a full length (L) to a full width (D) of a cylinder of the extruder is preferably 50 or more, and more preferably 60 or more. When the screw diameter is the above predetermined value or more and the L/D is the above predetermined value or more, deaeration is sufficiently carried out by pressure reduction of the vent section and the volatile component is less likely to remain in the composition, thus making it possible to obtain a composition in which the occurrence of blister at a high temperature is further suppressed.

Screw elements determining screw design typically consist of a transporting element composed of a forward flight, an element for a plasticizing section, and an element for a kneading section. In the case of the twin-screw extruder, a plasticizing section and a kneading section are generally combined with screw elements such as a reverse flight, a sealing, a forward kneading disk, and a reverse kneading disk.

The length of an opening of the vent section is preferably 0.5 to 5 times the screw diameter. When the length of the opening of the vent section is too small, the deaeration effect is insufficient. In contrast, when the length is too large, there is a fear that foreign matters are incorporated through the vent section, vent-up (ascending of a melted resin from the vent section) occurs and a transporting/kneading ability decreases.

The width of an opening of the vent section is preferably 0.3 to 1.5 times the screw diameter. When the width of an opening of the vent section is too small, the deaeration effect is insufficient. In contrast, when the width is too large, there is a fear that foreign matters are incorporated through the vent section, vent-up (ascending of a melted resin from the vent section) occurs and a transporting/kneading ability decreases.

The pressure of the vent section is typically reduced using a pump, and examples thereof include a water ring pump, a rotary pump, an oil diffusion pump and a turbo pump.

A sealing section into which a melted composition is completely filled is preferably provided at the upstream side of the vent section. In the case of the twin-screw extruder, as a screw shape constituting the sealing portion, one geometrically having a pressure rising ability to rotation of a screw, such as a reverse flight, a sealing, or reverse kneading is suitably used. If necessary, elements such as a kneading disk may be combined.

A structure of the screw element of the vent section is preferably a structure, which enables a decrease in barrel internal pressure, such as a forward flight or a forward kneading disk so as to prevent vent-up in the vent section. It is preferred that a pitch of the forward flight section is larger since the barrel internal pressure decreases. It is preferred to provide a screw structure having a high transporting capacity in front of the vent section for the same reason.

Each component may be fed into a feed inlet via a constant mass or constant volume feeder. Examples of the feeding system of a volumetric feeder include a system using a belt, a screw, vibration, or a table.

The feeding position of each component is appropriately selected. In the case of using a fibrous filler, it is preferred to feed a liquid crystalline polyester and mica through an upstream side feed inlet and to feed a fibrous filler through a downstream side feed inlet so as to uniformly perform melt kneading.

It is preferred that the vent section is provided at the downstream side of the downstream side feed inlet since it is possible to obtain a composition in which the occurrence of blister at a high temperature is further suppressed. It is more preferred to respectively provide the vent section at the upstream side and the downstream side of the downstream side feed inlet since it is possible to obtain a composition in which the occurrence of blister at a high temperature is further suppressed. When the vent section is provided in the vicinity of the upstream side feed inlet, or at the upstream side of the downstream side feed inlet, melting of the liquid crystalline polyester may become insufficient in the vicinity of the vent section and the deaeration effect may not be sufficiently obtained.

### <Molding of Composition>

By melt molding of the thus obtained composition of the present invention, it is possible to obtain a molded object which is less likely to cause blister at a high temperature, and to advantageously obtain a connector, particularly a long connector. The molding method is preferably an injection molding. The injection molding is preferably carried out at a temperature which is 10 to 80° C. higher than a flow initiation temperature of a liquid crystalline polyester contained in the composition. When the molding temperature is within this range, the composition exhibits excellent melt fluidity and, even in the case of molding a connector having an ultra-thin wall portion or a connector having a complicated shape, satisfactory moldability can be exhibited. Also, deterioration of a liquid crystalline polyester upon melt molding is prevented, and deterioration of characteristics of the connector is prevented. Even when the composition of the present invention is molded into a connector having a thin wall portion with a wall thickness of 0.1 mm or less, it becomes possible to sufficiently suppress the occurrence of warp. Also, the composition of the present invention is excellent in mechanical strength such as Izod impact strength or bending elastic modulus without impairing excellent heat resistance of a liquid crystalline polyester, and is therefore useful as a molding material of a connector to which thinning and complication of a shape are required more and more in future. This connector having a thin wall portion and a complicated shape is suited for electronic components used in a mobile device or the like.

### EXAMPLES

Hereinafter, examples of the present invention will be described, but the present invention is not limited thereto.

As mica, “AB-25S” (volume average particle diameter: 21 μm) manufactured by YAMAGUCHI MICA CO., LTD. was used.

### Production Example 1

In a reactor equipped with a stirrer, a torque meter, a nitrogen gas introducing tube, a thermometer and a reflux condenser, 994.5 g (7.2 mol) of p-hydroxybenzoic acid, 446.9 g (2.4 mol) of 4,4′-dihydroxybiphenyl, 299.0 g (1.8 mol) of terephthalic acid, 99.7 g (0.6 mol) of isophthalic acid and 1347.6 g (13.2 mol) of acetic anhydride were charged. After sufficiently replacing the atmosphere in the reactor with a nitrogen gas, 0.18 g of 1-methylimidazole was added and the temperature was raised to 150° C. over 30 minutes under a nitrogen gas flow, and then the mixture was refluxed for 30 minutes while maintaining the temperature. After adding 2.4 g of 1-methylimidazole, the temperature was raised to 320° C. over 2 hours and 50 minutes while distilling off acetic acid distilled as a by-product and the unreacted acetic anhydride. When an increase in torque was recognized, contents were taken out and then cooled to room temperature. The obtained solid was ground by a coarse grinder and then a solid phase polymerization was carried out under a nitrogen atmosphere by raising the temperature from room temperature to 250° C. over 1 hour, raising the temperature from 250° C. to 295° C. over 5 hours and maintaining at 295° C. for 3 hours. After the solid phase polymerization and cooling, the obtained liquid crystalline polyester is referred to as LCP 1. This LCP 1 had a flow initiation temperature of 327° C., a molar ratio (C₁)/(A₁) of 1/3, a molar ratio [(B₁)+(B₂)]/(C₁) of 1/1, and a molar ratio (B₂)/(B₁) of 1/3.

### Production Example 2

In a reactor equipped with a stirrer, a torque meter, to a nitrogen gas introducing tube, a thermometer and a reflux condenser, 994.5 g (7.2 mol) of p-hydroxybenzoic acid, 446.9 g (2.4 mol) of 4,4′-dihydroxybiphenyl, 239.2 g (1.44 mol) of terephthalic acid, 195.5 g (0.96 mol) of isophthalic acid and 1347.6 g (13.2 mol) of acetic anhydride were charged. After sufficiently replacing the atmosphere in the reactor with a nitrogen gas, 0.18 g of 1-methylimidazole was added and the temperature was raised to 150° C. over 30 minutes under a nitrogen gas flow, and then the mixture was refluxed for 30 minutes while maintaining the temperature. After adding 2.4 g of 1-methylimidazole, the temperature was raised to 320° C. over 2 hours and 50 minutes while distilling off acetic acid distilled as a by-product and the unreacted acetic anhydride. When an increase in torque was recognized, contents were taken out and then cooled to room temperature. The obtained solid was ground by a coarse grinder and then a solid phase polymerization was carried out under a nitrogen atmosphere by raising the temperature from room temperature to 220° C. over 1 hour, raising the temperature from 220° C. to 240° C. over 0.5 hours and maintaining at 240° C. for 10 hours. After the solid phase polymerization and cooling, the obtained liquid crystalline polyester is referred to as LCP 2. This LCP 2 had a flow initiation temperature of 286° C., a molar ratio (C₁)/(A₁) of 1/3, a molar ratio [(B₁)+(B₂)]/(C₁) of 1/1, and a molar ratio (B₂)/(B₁) of 2/3.

### Example 1

After a liquid crystalline polyester and mica were mixed in each proportion shown in Table 1, the mixture was fed in a twin-screw extruder having a vent section, a screw diameter of 41 mm and L/D of a cylinder of 62 and then melt-kneaded while maintaining the vent section at the degree of pressure reduction of −0.08 MPa in terms of a gauge pressure using a water ring pump to obtain a pellet-like composition. This composition was molded at a cylinder temperature of 350° C., a mold temperature of 130° C. and an injection rate of 60% using an injection molding machine (“PS40E1ASE”, manufactured by Nissei Plastic Industrial Co., Ltd.) to obtain JIS K7113 (1/2) dumbbell specimens (thickness: 1.2 mm). Ten specimens were immersed in a solder bath heated at 280° C. for 60 seconds. After taking out, the presence or absence of blister on a surface of the specimen was observed. A value (%) obtained by dividing the number of specimens with blister by total numbers (10) of specimens was taken as an occurrence percentage of blister. Then, the occurrence percentage is shown in Table 1.

### Example 2

The same operation as in Example 1 was carried out, except that the degree of pressure reduction of the vent section was maintained at −0.06 MPa in terms of a gauge pressure. The occurrence percentage of blister is shown in Table 1.

### Example 3

The same operation as in Example 1 was carried out, except that a twin-screw extruder having a vent section, a screw diameter of 58 mm and L/D of a cylinder of 46 was used as the extruder. The occurrence percentage of blister is shown in Table 1.

### Comparative Example 1

The same operation as in Example 1 was carried out, except that the water ring pump was not used and the pressure of the vent section was not reduced. The occurrence percentage of blister is shown in Table 1.

TABLE 1

| | | | | | Comparative |
|---|---|---|---|---|---|
| | | Example 1 | Example 2 | Example 3 | Example 1 |
| LCP1 | (Parts | 55 | 55 | 55 | 55 |
| | by | | | | |
| | weight) | | | | |
| LCP2 | (Parts | 45 | 45 | 45 | 45 |
| | by | | | | |
| | weight) | | | | |
| Mica | (Parts | 33.3 | 33.3 | 33.3 | 33.3 |
| | by | | | | |
| | weight) | | | | |
| Screw | (mm) | 41 | 41 | 58 | 41 |
| diameter | | | | | |
| L/D | (—) | 62 | 62 | 46 | 62 |
| Pressure | (MPa) | −0.08 | −0.06 | −0.08 | 0 |
| reduction | | | | | |
| degree of | | | | | |
| vent section | | | | | |
| Occurrence | (%) | 0 | 0 | 55 | 100 |
| percentage | | | | | |
| of blister | | | | | |

What is claimed is:

1. A method for producing a composition, the method comprising the steps of:
feeding a liquid crystalline polyester and mica into an extruder having a vent section, and
melt-kneading them under the conditions where the degree of pressure reduction of the vent section is −0.06 MPa or less in terms of a gauge pressure.

2. The method for producing a composition according to claim 1, wherein the extruder has a screw diameter of 50 mm or less.

3. The method for producing a composition according to claim 1, wherein the extruder has a cylinder in which a proportion (L/D) of a full length (L) to a full width (D) is of is 50 or more.

4. The method for producing a composition according to claim 1, wherein the liquid crystalline polyester has a structural unit represented by the following formula (A₁): 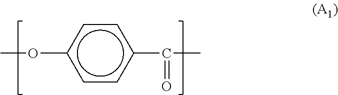
in the amount of 30 mol % or more based on the total of all structural units.

5. The method for producing a composition according to claim 1, wherein the mica has a volume average particle diameter of from 1 to 100 μm.

6. The method for producing a composition according to claim 1, wherein the mica is fed in the amount of from 15 to 100 parts by mass based on the liquid crystalline polyester.

7. A connector obtained by the method according to claim 1.

8. The connector according to claim 7, which has a thin wall portion having a wall thickness of 0.1 mm or less.
